(19) United States
(12) Patent Application Publication
(10) Pub. No.: US 2025/0218280 A1
(43) Pub. Date: Jul. 3, 2025

(54) Quantum mechanics and inspiration zone/s duplicating device

(71) Applicant: Menni Menashe Zinger, Ashkelon (IL)

(72) Inventor: Menni Menashe Zinger, Ashkelon (IL)

(21) Appl. No.: 18/445,722

(22) Filed: Dec. 29, 2023

(51) Int. Cl. G08C 17/00

(52) U.S. Cl. CPC G08C 17/00

(57) ABSTRACT

at this invention I present a duplicating device.

using a double or multiple box/es unit that gas magnetic/electromagnetic/electric field/t.v. Waves/radio waves and frequencies and microwaves and frequencies power inspiration from one cell of the unit to the other/s with using quantum mechanics and inspiration zones when the first cell is the model and the item inside is the figure and duplicating/multiplying the item/es in cell one into cell two and three and so on or using two cells only and using receiver aimed towards the first cell with original product and transmitter aimed towards the second cell that is used in order to contain same size or other size of same product and for other additional cells the same and antenna that transmit between the receiver and transmitter and/or communication cable/s/electric cable/s and the magnetic/electro magnetic/electric field/t.v. Waves/radio waves and frequencies and microwaves and frequencies would create inspiration from first cell into the second and the product would be duplicate/multiplied at second cell of duplicating unit and the cists of production would be all most zero money and effort and time of work and also gold, diamond, rare metals and rare materials and stakes and other expensive things can be duplicated. see also my invention

Ser. No. 17/548,511, time machines 2, usa, and my invention Ser. No. 17/080,105, usa and my invention number 266246, Israel and my invention number 279390, Israel and my invention number 287097, Israel, and my invention number 280289, Israel.

1. using a double or multiple box/es unit that gas magnetic/electromagnetic/electric field/t.v. Waves/radio waves and frequencies and microwaves and frequencies power inspiration from one cell of the unit to the other/s with using quantum mechanics and inspiration zones when the first cell is the model and the item inside is the figure and duplicating/multiplying the item/es in cell one into cell two and three and so on or using two cells only and using receiver aimed towards the first cell with original product and transmitter aimed towards the second cell that is used in order to contain same size or other size of same product and for other additional cells the same and antenna that transmit between the receiver and transmitter and/or communication cable/s/electric cable/s and the magnetic/electro magnetic/electric field/t.v. Waves/radio waves and frequencies and microwaves and frequencies would create inspiration from first cell into the second and the product would be duplicate/multiplied at second cell of duplicating unit and the cists of production would be all most zero money and effort and time of work and also gold, diamond, rare metals and rare materials and stakes and other expensive things can be duplicated. see also my invention Ser. No. 17/548,511, time machines 2, usa, and my invention Ser. No. 17/080,105, usa and my invention number 266246, Israel and my invention number 279390, Israel and my invention number 287097, Israel, and my invention number 280289, Israel.
